(19) United States
(12) Patent Application Publication
(10) Pub. No.: US 2021/0294613 A1
(43) Pub. Date: Sep. 23, 2021

(54) METHOD AND SYSTEM FOR DUAL MODE BOOT-UP IN MULTI-FUNCTION DEVICE

(71) Applicant: TOSHIBA TEC KABUSHIKI KAISHA, Tokyo (JP)

(72) Inventor: Rahul KUMAR, Bangalore (IN)

(73) Assignee: TOSHIBA TEC KABUSHIKI KAISHA, Tokyo (JP)

(21) Appl. No.: 17/073,091

(22) Filed: Oct. 16, 2020

(30) Foreign Application Priority Data
Mar. 17, 2020 (IN) 202041011468

(51) Int. Cl. G06F 9/4401; G06F 9/48; G06F 9/50

(52) U.S. Cl. CPC G06F 9/4411; G06F 9/5044; G06F 9/4881

(57) ABSTRACT

A method and a system for operating a multi-function device are provided. The method includes receiving a user selection of one of multiple modes to boot a multi-function device, wherein the multiple modes comprise at least a light duty mode and a heavy duty mode, initializing the multi-function device with primary drivers and primary hardware components that are required for minimum functionality of the multi-function device, when the user selection is the light duty mode or when the user selection is not received for a predetermined period of time, and deactivating secondary drivers and secondary hardware components of the multi-function device by disconnecting power supplied to the secondary drivers and the secondary hardware components when the user selection is the light duty mode or when the user selection is not received for the predetermined period of time.

### TECHNICAL FIELD

The present subject matter is generally related to multi-function devices, more particularly, but not exclusively, to a method and a system for dual mode boot-up in a multi-function device.

### BACKGROUND

A multi-function device refers to a device or a machine that incorporates multiple functionalities in one. Multiple functionalities include email, fax, photocopying, printing, scanning and the like. As multi-function device supports many features and may consume a lot of power.

The information disclosed in this background of the disclosure section is for enhancement of understanding of the general background of the disclosure and should not be taken as an acknowledgement or any form of suggestion that this information forms the prior art already known to a person skilled in the art.

### SUMMARY

Typically, not all the features of a multi-function device are used at all times. For example, it is possible that the multi-function device is executing only print job for a whole day and rest of the functionalities are not utilized. In such situations, drivers and hardware components related to all the multi-function device features are continuously running irrespective of whether they are being utilized or not. This results in a waste of large amounts of power. In at least one embodiment, the present disclosure may relate to a method for operating a multi-function device. The method includes receiving a user selection of one of multiple modes to boot a multi-function device, wherein the multiple modes comprise at least a light duty mode and a heavy duty mode. In the next step, the method includes initializing the multi-function device with primary drivers and primary hardware components that are required for minimum functionality of the multi-function device, when the user selection is the light duty mode or when the user selection is not received for a predetermined period of time. In the final step, the method includes deactivating secondary drivers and secondary hardware components of the multi-function device by disconnecting power supplied to the secondary drivers and the secondary hardware components when the user selection is the light duty mode or when the user selection is not received for the predetermined period of time.

In at least one embodiment, the present disclosure may relate to a boot-up assisting system for operating a multi-function device. The boot-up assisting system may include a processor and a memory communicatively coupled to the processor, wherein the memory stores processor-executable instructions, which on execution, cause the processor to receive a user selection of one of multiple modes to boot a multi-function device, wherein the multiple modes comprise at least a light duty mode and a heavy duty mode. In the next step, the boot-up assisting system initializes the multi-function device with primary drivers and primary hardware components that are required for minimum functionality of the multi-function device, when the user selection is the light duty mode or when the user selection is not received for a predetermined period of time. In the final step, the boot-up assisting system deactivates secondary drivers and secondary hardware components of the multi-function device by disconnecting power supplied to the secondary drivers and the secondary hardware components when the user selection is the light duty mode or when the user selection is not received for the predetermined period of time.

In at least one embodiment, the present disclosure may relate to a non-transitory computer readable medium including instructions stored thereon that when processed by at least one processor cause a boot-up assisting system to perform acts of receiving a user selection of one of multiple modes to boot a multi-function device, wherein the multiple modes comprise at least a light duty mode and a heavy duty mode. Thereafter, the instructions cause the at least one processor to initialize the multi-function device with primary drivers and primary hardware components that are required for minimum functionality of the multi-function device, when the user selection is the light duty mode or when the user selection is not received for a predetermined period of time. Subsequently, the instructions cause the at least one processor to deactivate secondary drivers and secondary hardware components of the multi-function device by disconnecting power supplied to the secondary drivers and the secondary hardware components when the user selection is the light duty mode or when the user selection is not received for the predetermined period of time.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

FIG. 1 illustrates an exemplary environment for operating a multi-function device in accordance with some embodiments of the present disclosure.

FIG. 2 shows a detailed block diagram of a boot-up assisting system in accordance with some embodiments of the present disclosure.

FIGS. 3a-3b illustrate a flowchart showing a method for operating a multi-function device in accordance with some embodiments of the present disclosure.

FIG. 4 illustrates an exemplary representation of operating a multi-function device when a job is submitted in accordance with some embodiments of the present disclosure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure provide dual boot modes in multi-function devices for energy saving purpose. In the dual boot modes, a multi-function device has capacity to boot up in one of two modes (a) light duty mode and (b) heavy duty mode. In the light duty mode, the multi-function device boots up with only those drivers and hardware components that are important and are responsible for booting up the multi-function device. However, in the light mode, the drivers and hardware components that are not required for booting up the multi-function device such as a scanner unit, a print unit and the like are not initialized. When the multi-function device receives a job, then based on the type of job, the multi-function device initializes and runs the drivers and hardware components that are relevant in performing the received job. Once the job is executed, the drivers and hardware components relevant to the executed job are deactivated. In the heavy duty mode, the multi-function device boots up by initializing all the drivers and hardware components. The implementation of light duty mode in multi-function devices result in efficient utilization of drivers and hardware components, thereby, increasing longevity of drivers and hardware components. Additionally, the light duty mode allows reduction of multi-function device energy consumption significantly.

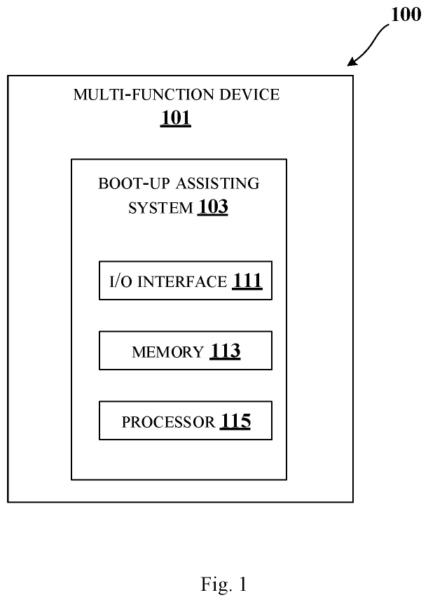

FIG. 1 illustrates an exemplary environment for operating a multi-function device in accordance with some embodiments of the present disclosure.

As shown in the FIG. 1, the environment 100 includes a multi-function device 101 and a boot-up assisting system 103. The multi-function device 101 may be connected through the communication network (not shown in FIG. 1) to the boot-up assisting system 103. In at least one embodiment, the boot-up assisting system 103 may be part of the multi-function device 101. In an embodiment, the multi-function device 101 may refer to a device or a machine that is capable of multiple functionality through units that include, but is not limited to, a scanner unit, a printer unit, a copier unit, a fax unit and a network unit. Here, the fax unit may comprise a combination of the scan unit and the network unit and a combination of the print unit and the network unit. The multi-function device 101 may also be called a multi-function product, a multi-function printer or a multi-functional peripheral. In an embodiment, the multi-function device 101 may have the capacity to boot up in one of two modes: (a) light duty mode, and (b) heavy duty mode. The heavy duty mode may also be referred as normal mode.

In the light duty mode, the multi-function device 101 may boot up with only those hardware components and drivers that are important and are responsible for booting up the multi-function device 101. These hardware components and drivers may be referred as primary hardware components and primary drivers, respectively. The primary drivers and primary hardware components may comprise drivers, a main processor and a display panel. Therefore, when the user selection is the light duty mode, the multi-function device 101 uses the minimum power that is supplied leading to efficient usage of power. In the light duty mode, the hardware components and drivers which are not needed for boot up of the multi-function device 101 are deactivated. These hardware components and drivers may be referred as secondary hardware components and secondary drivers, respectively. The secondary drivers and secondary hardware components may comprise a scanner unit, a printer unit, a copier unit, a fax unit, a network unit and a peripheral hardware devices. Additionally, the secondary drivers and secondary hardware components may comprise peripheral hardware devices (not shown in FIG. 1) that may be connected to the multi-function device 101 such as a finisher, a saddle, a punch, a coin collector and the like. A peripheral device is an internal or an external device that may connect directly to the multi-functional device 101. The peripheral device may help end users access and may use the functionalities of the multi-functional device 101. A saddle is a peripheral hardware device that may be attached to the multi-functional device 101. The saddle may perform book binding using staple binding for multiple sheets. Output/copy sheets from the multi-functional device 101 may be fed directly to the attached saddle, which staples the sheets together for binding. A punch is a peripheral hardware device that may be used to punch holes in the output/copy sheets for book/spiral binding of multiple sheets. A coin collector is a peripheral device that may be attached to multi-functional devices in public that are available in market. A user may perform any job on multi-functional devices in public and may pay money through a coin collector as per the job rate similar to payment application using mobile device. A finisher is a peripheral hardware device that may help users to create book, bind, staple, hole-punch, crease, slit, trim and the like. The finisher may help to create books, booklets, presentations, greeting cards, and many other applications that may require manipulation of the job inline and/or post printing.

In at least one embodiment, when the user selection is not received for a predetermined period of time after the multi-function device 101 is switched ON, the multi-function device 101 may boot up in the light duty mode. In at least one embodiment, when the multi-function device 101 may receive any job for execution, then based on the type of job, the multi-function device 101 may initialize and run the hardware components and drivers that are relevant in performing the received job. After the job completion, the hardware components and drivers initialized for the job execution may be deactivated. In at least one embodiment, the deactivating of the initialized hardware components and drivers may be performed after a predetermined period of time after completion of the job.

In contrast to the light duty mode, in the heavy duty mode, the multi-function device 101 may boot up by fully initializing all hardware components and drivers i.e. the primary drivers, the primary hardware components, the secondary drivers and the secondary hardware components. Therefore, when the user selection is the heavy duty mode, the multi-function device 101 uses full power supply. During boot-up a user may be provided with option to provide a selection between the light duty mode and heavy duty mode. User input data may be a user selection between the light duty mode and the heavy duty mode. The user input may be received through a user interface on a display panel (not shown in FIG. 1) attached to the multi-function device 101.

In at least one embodiment, the boot-up assisting system 103 may receive a user selection of one of multiple modes. The multiple modes may comprise at least a light duty mode and a heavy duty mode. Based on the user selection, the boot-up assisting system 103 may activate and/or deactivate relevant hardware components and drivers. The boot-up assisting system 103 may include an I/O interface 111, a memory 113 and a processor 115. The I/O interface 111 may be configured to receive the user input data from the multi-function device 101.

The user input data received by the I/O interface 111 may be stored in the memory 113. The memory 113 may be communicatively coupled to the processor 115 of the boot-up assisting system 103. The memory 113 may also store processor instructions which may cause the processor 115 to execute the instructions for operating the multi-function device 101. The memory 113 may include, without limitation, memory drives, removable disc drives, etc. The memory drives may further include a drum, magnetic disc drive, magneto-optical drive, optical drive, Redundant Array of Independent Discs (RAID), solid-state memory devices, solid-state drives, etc.

The processor 115 may include at least one data processor for operating a multi-function device. The processor 115 may include specialized processing units such as integrated system (bus) controllers, memory management control units, floating point units, graphics processing units, digital signal processing units, etc.

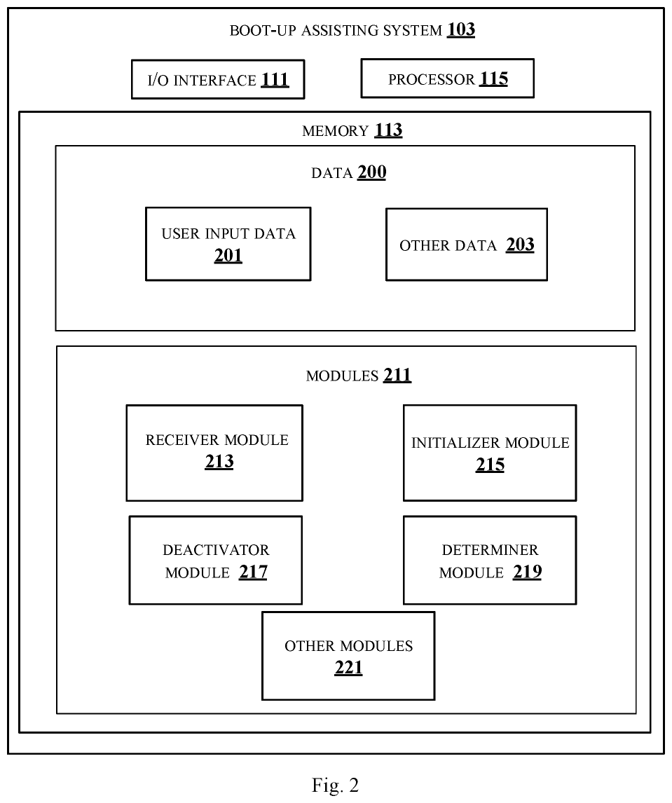

FIG. 2 shows a detailed block diagram of a boot-up assisting system in accordance with some embodiments of the present disclosure.

The boot-up assisting system 103, in addition to the I/O interface 111 and processor 115 described above, may include data 200 and one or more modules 211, which are described herein in detail. In at least one embodiment, the data 200 may be stored within the memory 113. The data 200 may include, for example, user input data 201 and other data 203.

The user input data 201 may include a user selection of one of multiple modes to boot a multi-function device. The multiple modes may comprise at least a light duty mode and a heavy duty mode. The user selection received by the boot-up assisting system 103 from the multi-function device 101 are stored in the user input data 201.

The other data 203 may store data, including temporary data and temporary files, generated by one or more modules 211 for performing the various functions of the boot-up assisting system 103.

In at least one embodiment, the data 200 in the memory 113 are processed by the one or more modules 211 present within the memory 113 of the boot-up assisting system 103. In at least one embodiment, the one or more modules 211 may be implemented as dedicated hardware units. As used herein, the term module refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide the described functionality. In some implementations, the one or more modules 211 may be communicatively coupled to the processor 115 for performing one or more functions of the boot-up assisting system 103. The modules 211 when configured with the functionality defined in the present disclosure will result in a novel hardware.

In one implementation, the one or more modules 211 may include, but are not limited to, a receiver module 213, an initializer module 215, a deactivator module 217 and a determiner module 219. The one or more modules 211 may, also, include other modules 221 to perform various miscellaneous functionalities of the boot-up assisting system 103.

The receiver module 213 may receive a user selection of one of multiple modes to boot the multi-function device 101. The multiple mode may comprise at least a light duty mode and a heavy duty mode. The user selection may be received through a user interface on a display panel attached of the multi-function device 101. In an embodiment, a user may be shown the light duty mode and the heavy duty mode on the display panel. At this point, the user may select either the light duty mode or the heavy duty mode.

The initializer module 215 may initialize the multi-function device 101 depending on the user selection received by the receiver module 213. In an embodiment, when the user selection is the light duty mode, the initializer module 215 may initialize the multi-function device 101 with primary drivers and primary hardware components that are required for minimum functionality of the multi-function device. In at least one embodiment, when the user selection is the heavy duty mode, the initializer module 215 may initialize the multi-function device 101 with the primary drivers, the primary hardware components, the secondary drivers and the secondary hardware components that are required for complete functionality of the multi-function device 101. In an embodiment, when the multi-function device 101 is switched ON, the initializer module 215 may wait for a predetermined period of time to receive a user selection on the display panel. When the user selection is not received for the predetermined period of time, the initializer module 215 may initialize the multi-function device 101 with primary drivers and primary hardware components that are required for minimum functionality of the multi-function device. In brief, when the user selection is not received for the predetermined period of time, the initializer module 215 may initialize the multi-function device 101 in the light duty mode. This setting may be changed to the heavy duty mode when the user selection is not received for the predetermined period of time if required by the user. In at least one embodiment, when the initializer module 215 initializes the multi-function device 101 in the light duty mode, the initializer module 215 may check memory of the multi-function device 101 for any pending jobs. When one or more jobs is detected in the memory of the multi-function device 101, the initializer module 215 may initialize at least one of the secondary drivers and the secondary hardware components of the multi-function device based on a type of the one or more job. In at least one embodiment, when a job is submitted by a user, the initializer module 215 may initialize at least one of secondary drivers and secondary hardware components of the multi-function device 101 based on the type of the job. The primary drivers and primary hardware components may comprise drivers, a main processor and a display panel. The secondary drivers and secondary hardware components may comprise a scanner unit, a printer unit, a copier unit, a fax unit (facsimile machine), a network unit (network interface) and peripheral hardware devices.

The deactivator module 217 may deactivate the multi-function device 101 based on the initialization of the multi-function device 101 in the light duty mode or the heavy duty mode. In an embodiment, when the multi-function device 101 is in the light duty mode, the deactivator module 217 may deactivate the secondary drivers and secondary hardware components of the multi-function device 101 by disconnecting power supplied to the secondary drivers and the secondary hardware components. In at least one embodiment, the deactivator module 217 may disconnect power supplied to the secondary drivers and the secondary hardware components after a predefined time after a job is completed. The predetermined time could be a few minutes to an hour. In at least one embodiment, when the multi-function device 101 is in the heavy duty mode, the deactivator module 217 may deactivate the secondary drivers and secondary hardware components of the multi-function device 101 when the mode is changed from the heavy duty mode to the light duty mode. This mode change may be initiated by the user via the user interface on the display panel of the multi-function device 101. In at least one embodiment, the deactivator module 217 may deactivate the initialized at least one of secondary drivers and secondary hardware components of the multi-function device 101 after completion of the job in the memory. In at least one embodiment, the deactivator module 217 may deactivate at least one of secondary drivers and secondary hardware components of the multi-function device 101 after completion of a job that was submitted by a user for execution.

The determiner module 219 may determine a type of the job received by the receiver module 213 that was submitted by a user for execution. Based on the type of job determined by the determiner module 219, the initializer module 215 in the subsequent step may initialize at least one of secondary drivers and secondary hardware components of the multi-function device 101. For example, if the determiner module 219 determines the type of the job received by the receiver module 213 is a printing job, then the initializer module 215 initializes secondary drivers and secondary hardware components required for executing the printing job.

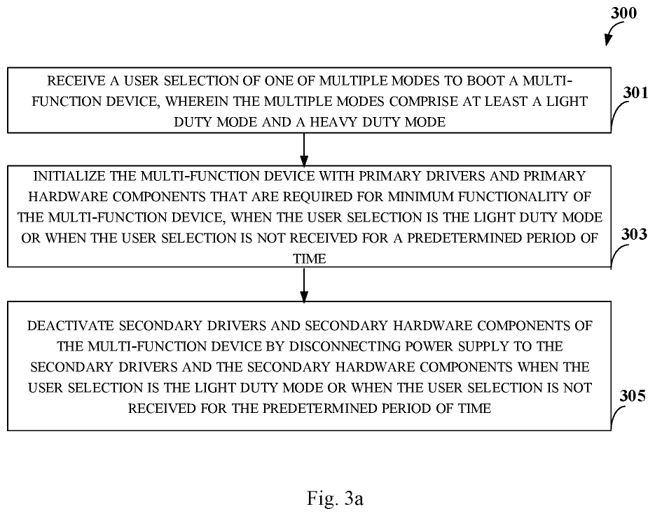

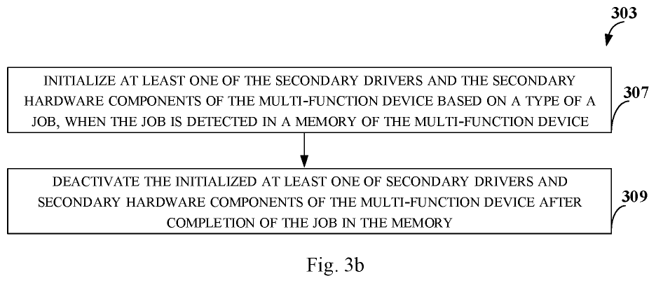

FIGS. 3a-3b illustrate a flowchart showing a method for operating a multi-function device in accordance with some embodiments of present disclosure.

As illustrated in FIGS. 3a-3b, the method 300 includes one or more blocks for operating a multi-function device 101. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 301, the receiver module 213 may receive a user selection of one of multiple modes to boot the multi-function device 101. The multiple modes may comprise at least a light duty mode and a heavy duty mode. Prior to receiving the user selection, when the multi-function device 101 is switched ON or activated, multiple modes may be displayed on a display attached to the multi-function device 101. At this point, a user may select one of the multiple modes on the display. This user selection may be received by the receiver module 213.

At block 303, the initializer module 215 may initialize the multi-function device 101 with primary drivers and primary hardware components that are required for minimum functionality of the multi-function device 101. This initializing step may be performed when the user selection received by the receiver module 213 is the light duty mode or when the user selection is not received for a predetermined period of time. The period could be a few seconds to a couple of minutes. In case of a situation, when the user selection is not received from the user on the display attached to the multi-function device 101 for the predetermined period of time, the initializer module 215 may initialize the multi-function device 101 with primary drivers and primary hardware components that are required for minimum functionality of the multi-function device 101.

At block 305, the deactivator module 217 may deactivate secondary drivers and secondary hardware components of the multi-function device 101 by disconnecting power supplied to the secondary drivers and the secondary hardware components. This deactivating step may be performed when the user selection is the light duty mode or when the user selection is not received for the predetermined period of time. In case of a situation, when the user selection was not received from the user at block 303 and the multi-function device 101 was initialized with primary drivers and primary hardware components, the deactivator module 217 may deactivate secondary drivers and secondary hardware components.

FIG. 3b illustrates a flowchart showing a method for operating a multi-function device when a job is detected in a memory in accordance with some embodiments of present disclosure.

At block 307, during the initialization process at block 303, the initializer module 215 may check if there is any job stored in a memory of the multi-function device 101. When the job is detected in the memory of the multi-function device 101, the initializer module 215 may initialize at least one of the secondary drivers and the secondary hardware components of the multi-function device 101 based on a type of a job.

At block 309, the deactivator module 217 may deactivate the initialized at least one of secondary drivers and secondary hardware components of the multi-function device 101 at the block 307 after completion of the job in the memory.

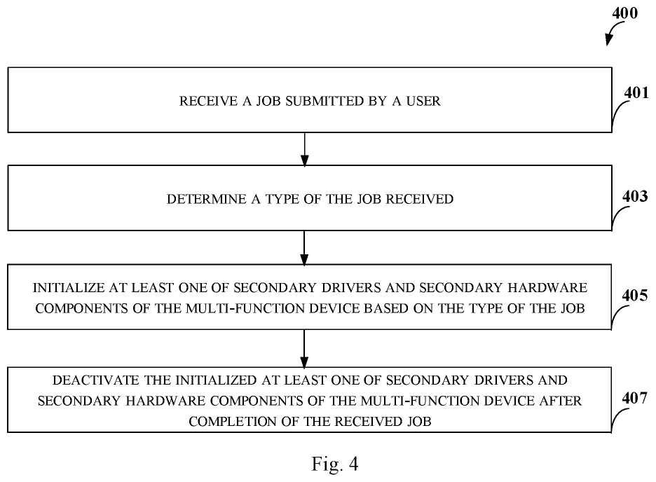

FIG. 4 illustrates an exemplary representation of operating a multi-function device 101 when a job is submitted in accordance with some embodiments of present disclosure.

At block 401, the receiver module 213 may receive a job submitted by a user.

At block 403, the determiner module 219 may determine a type of the job received at the block 401.

At block 405, the initializer module 215 may initialize at least one of secondary drivers and secondary hardware components of the multi-function device 101 based on the type of the job.

At block 407, the deactivator module 219 may deactivate the initialized at least one of secondary drivers and secondary hardware components of the multi-function device 101 after completion of the received job.

A few examples are presented below based on FIGS. 3a, 3b and 4.

Example 1: User wants to perform copy job. Here, copy job means the user wants to print submitted/stored documents on the multi-function device 101.

Suppose the multi-function device 101 is in idle state (not executing any job) in the light duty mode, then the secondary drivers and secondary hardware components, will remain inactive (no power supplied for the secondary drivers and secondary hardware components). When a user wants to execute any job, then the user needs to manually start the relevant hardware units (from the display panel of the multi-function device 101 or from remote desktop which has software of the multi-function device 101 installed) before submitting the jobs. To perform a copy job, the user clicks on “Wake Copy” button on user-functions screen (user interface on the display panel) of the multi-function device 101. Clicking on this button, the boot-up assisting system 103 initializes the print unit and all peripheral components connected to the multi-function device 101 (finisher, saddle, punch, etc). Also, now this button gets dimmed (user cannot press it again). The user submits copy jobs and the multi-function device 101 executes the job. Once job execution is finished, the boot-up assisting system 103 keeps the print unit and peripheral devices of the multi-function device 101 running for specified time (the predetermined period of time). This way the user gets buffer time to submit another copy job. After the specified time (after the predetermined period of time after completion of the job) if the boot-up assisting system 103 detects that no copy job is pending, then the boot-up assisting system 103 automatically stops power supplied to the print unit and peripheral devices. Hence, the boot-up assisting system 103 de-activates the print unit and peripheral devices. Now, “wake copy” button is once again available for the user to press.

Example 2: User wants to perform scan job. Here, scan job means the user wants to scan documents and store them on the multi-function device 101.

Suppose the multi-function device 101 is in an idle state (not executing any job) in the light duty mode, then the secondary drivers and secondary hardware components, will remain inactive (no power supplied for the secondary drivers and secondary hardware components). When a user wants to execute any job, then the user needs to manually start the relevant hardware units (from the display panel of the multi-function device 101 or from remote desktop which has software of the multi-function device 101 installed) before submitting the jobs. To perform a scan job, the user clicks on “Wake Scan” button on user-functions screen (user interface on the display panel) of the multi-function device 101. Clicking on this button, the boot-up assisting system 103 initializes the scan unit. Also, now this button gets dimmed (user cannot press it again). The user submits scan jobs and the multi-function device 101 executes the jobs. Once job execution is finished, the boot-up assisting system 103 keeps the scan unit of the multi-function device 101 running for specified time (the predetermined period of time). In this way the user gets buffer time to submit another scan job. After the specified time (after the predetermined period of time after completion of the job) if the boot-up assisting system 103 detects that no scan job is pending, then the boot-up assisting system 103 automatically stops power supply to the scan unit. Hence, the boot-up assisting system 103 de-activates the scan unit. Now, “wake Scan” button is once again available for user to press.

Example 3: User wants to perform fax job for sending.

Suppose the multi-function device 101 is in an idle state (not executing any job) in the light duty mode, then the secondary drivers and secondary hardware components, will remain inactive (no power supply for the secondary drivers and secondary hardware components). When a user wants to execute any job, then the user needs to manually start the relevant hardware units (from the display panel of the multi-function device 101 or from remote desktop which has software of the multi-function device 101 installed) before submitting the jobs. To perform a fax send job, the user clicks on “Wake Fax send” button on the user-functions screen (user interface on the display panel) of the multi-function device 101. Clicking on this button, the boot-up assisting system 103 initializes the scan unit and the network unit. Also, now this button gets dimmed (user cannot press it again). The user submits a fax send job and the multi-function device 101 executes the job. Once job execution is finished, the boot-up assisting system 103 keeps scan unit and network unit running for specified time (the predetermined period of time). This way the user gets buffer time to submit another fax send job. After the specified time (or after the predetermined period of time after completion of the job) if the boot-up assisting system 103 detects that no fax send job is pending, then the boot-up assisting system 103 automatically stops power supplied to the scan unit and network unit. Hence, the boot-up assisting system 103 de-activates the scan unit and network unit. Now, “wake Fax Send” button is once again available for the user to press.

Example 4: User wants to perform fax job for receiving.

Suppose the multi-function device 101 is in an idle state (not executing any job) in the light duty mode, then the secondary drivers and secondary hardware components, will remain inactive (no power supplied for the secondary drivers and secondary hardware components). When a user wants to execute any job, then the user needs to manually start the relevant hardware units (from the display panel of the multi-function device 101 or from remote desktop which has software of the multi-function device 101 installed) before submitting the jobs. To perform a fax receive job, user clicks on “Wake Fax receive” button on user-functions screen (user interface on the display panel) of the multi-function device 101. Clicking on this button, the boot-up assisting system 103 initializes the print unit, connected peripheral devices and the network unit. Also, now this button gets dimmed (user cannot press it again). The multi-function device 101 receives incoming fax jobs via LAN network and executes the jobs. Once job execution is finished, the boot-up assisting system 103 keeps the print unit, the peripheral devices and the network unit running for specified time (the predetermined period of time). This way user gets buffer time to submit another fax receive job. After the specified time (or after the predetermined period of time after completion of the job) if the boot-up assisting system 103 detects that no fax receive job is pending, then the boot-up assisting system 103 automatically stops power supplied to the print unit, the peripheral devices and the network unit. Hence, the boot-up assisting system 103 de-activates the print unit, peripheral devices and network unit. Now, “wake Fax Receive” button is once again available for user to press.

Example 5: User wants to perform remote/network print job.

In remote/network print job, the user submits a document for printing via a device such as remote desktop, laptop or a mobile phone. When the user selects print option for any document on his/her device, then a screen may appear on the device with a print option. When the user presses “Print” button, then in normal boot mode (heavy duty mode) the document is sent to the multi-function device 101 and is then printed-out by the multi-function device 101 using the boot-up assisting system 103. In case of the light-duty boot mode, when the user presses on “Print” button on his/her device, then print job is not sent to the connected the multi-function device 101. Instead the user is sent a push message on his/her device by the boot-up assisting system 103, asking the user to allow waking up print unit of the multi-function device 101. If the user selects “yes”, then document is sent from a user's device connected to the multi-function device 101. Only the print unit and peripheral devices required for printing are enabled, and the multi-function device 101 prints the documents. After the specified time (or after the predetermined period of time after completion of the job) if the boot-up assisting system 103 detects that no print job is pending, then the boot-up assisting system 103 automatically stops power supplied to the print unit and the peripheral devices. Hence, the boot-up assisting system 103 de-activates the print unit and peripheral devices.

Some of the advantages of the present disclosure are listed below.

The present disclosure allows reducing large amounts of energy consumed by the multi-function device when the multi-function device is booted up in a light duty mode.

The present disclosure uses secondary drivers and secondary hardware components only when needed. This allows optimum usage of the secondary drivers and secondary hardware components, thereby, increasing product lifespan.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor is at least one of a microprocessor or a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), Application Specific Integrated Circuit (ASIC), etc.).

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise. The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

The illustrated operations of FIGS. 3a, 3b and 4 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the disclosure of the embodiments of the disclosure is intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for operating a multi-function device, the method comprising:
receiving, by a boot-up assisting system, a user selection of one of multiple modes to boot a multi-function device, wherein the multiple modes comprise at least a light duty mode and a heavy duty mode;
initializing, by the boot-up assisting system, the multi-function device with primary drivers and primary hardware components that are required for minimum functionality of the multi-function device, when the user selection is the light duty mode or when the user selection is not received for a predetermined period of time; and
deactivating, by the boot-up assisting system, secondary drivers and secondary hardware components of the multi-function device by disconnecting power supplied to the secondary drivers and the secondary hardware components when the user selection is the light duty mode or when the user selection is not received for the predetermined period of time.

2. The method as claimed in claim 1, wherein the secondary drivers and secondary hardware components comprise one or more of a scanner, a printer, a copier, a facsimile machine, a network interface or a peripheral hardware devices, and
wherein the primary drivers and primary hardware components comprise one or more of drivers, a main processor or a display panel.

3. The method as claimed in claim 1, further comprising using minimum power supplied by the multi-function device when the user selection is the light duty mode and using full power supplied by the multi-function device when the user selection is the heavy duty mode.

4. The method as claimed in claim 1, further comprising:
receiving, by the boot-up assisting system, a job submitted by a user;
determining, by the boot-up assisting system, a type of the job received;
initializing, by the boot-up assisting system, at least one of secondary drivers or secondary hardware components of the multi-function device based on the type of the job; and
deactivating, by the boot-up assisting system, the initialized at least one of secondary drivers or secondary hardware components of the multi-function device after completion of the received job.

5. The method as claimed in claim 1, wherein the initializing of the multi-function device, when the user selection is the light duty mode further comprises:
initializing, by the boot-up assisting system, at least one of the secondary drivers or the secondary hardware components of the multi-function device based on a type of a job, when the job is detected in a memory of the multi-function device; and
deactivating, by the boot-up assisting system, the initialized at least one of secondary drivers or secondary hardware components of the multi-function device after completion of the job in the memory.

6. The method as claimed in claim 1, further comprising:
initializing, by the boot-up assisting system, the multi-function device with the primary drivers, the primary hardware components, the secondary drivers and the secondary hardware components that are required for complete functionality of the multi-function device, when the user selection is the heavy duty mode.

7. The method as claimed in claim 4, wherein the deactivating of the initialized at least one of secondary drivers or secondary hardware components is performed after the predetermined period of time after completion of the job.

8. A boot-up assisting system for operating a multi-function device, the system comprising:
a processor; and
a memory communicatively coupled to the processor, wherein the memory stores processor-executable instructions, which on execution, cause the processor to:
receive a user selection of one of multiple modes to boot a multi-function device, wherein the multiple modes comprise at least a light duty mode and a heavy duty mode;
initialize the multi-function device with primary drivers and primary hardware components that are required for minimum functionality of the multi-function device, when the user selection is the light duty mode or when the user selection is not received for a predetermined period of time; and
deactivate secondary drivers and secondary hardware components of the multi-function device by disconnecting power supplied to the secondary drivers and the secondary hardware components when the user selection is the light duty mode or when the user selection is not received for the predetermined period of time.

9. The boot-up assisting system as claimed in claim 8, wherein the secondary drivers and secondary hardware components comprise at least one of a scanner, a printer, a copier, a fascimile machine, a network interface or peripheral hardware devices, and
wherein the primary drivers and primary hardware components comprise at least one of drivers, a main processor or a display panel.

10. The boot-up assisting system as claimed in claim 8, the system causes the processor to use minimum power supplied by the multi-function device when the user selection is the light duty mode and use full power supplied by the multi-function device when the user selection is the heavy duty mode.

11. The boot-up assisting system as claimed in claim 8, the system causes the processor to:
receive a job submitted by a user;
determine a type of the job received;
initialize at least one of secondary drivers or secondary hardware components of the multi-function device based on the type of the job; and
deactivate the initialized at least one of secondary drivers or secondary hardware components of the multi-function device after completion of the received job.

12. The boot-up assisting system as claimed in claim 8, the system causes the processor to:
initialize at least one of the secondary drivers or the secondary hardware components of the multi-function device based on a type of a job, when the job is detected in a memory of the multi-function device; and
deactivate the initialized at least one of secondary drivers or secondary hardware components of the multi-function device after completion of the job in the memory.

13. The boot-up assisting system as claimed in claim 8, the system causes the processor to:
initialize the multi-function device with the primary drivers, the primary hardware components, the secondary drivers and the secondary hardware components that are required for complete functionality of the multi-function device, when the user selection is the heavy duty mode.

14. The boot-up assisting system as claimed in claim 11, wherein the deactivating of the initialized at least one of secondary drivers or secondary hardware components is performed after the predetermined period of time after completion of the job.

15. A non-transitory computer readable medium including instructions stored thereon which, when processed by at least one processor, cause a boot-up assisting system to perform operations comprising:
receiving a user selection of one of multiple modes to boot a multi-function device, wherein the multiple modes comprise at least a light duty mode and a heavy duty mode;
initializing the multi-function device with primary drivers and primary hardware components that are required for minimum functionality of the multi-function device, when the user selection is the light duty mode or when the user selection is not received for a predetermined period of time; and
deactivating secondary drivers and secondary hardware components of the multi-function device by disconnecting power supplied to the secondary drivers and the secondary hardware components when the user selection is the light duty mode or when the user selection is not received for the predetermined period of time.

16. The non-transitory computer readable medium as claimed in claim 15, wherein the operations further comprise using minimum power supplied by the multi-function device when the user selection is the light duty mode and using full power supplied by the multi-function device when the user selection is the heavy duty mode.

17. The non-transitory computer readable medium as claimed in claim 15, wherein the operations further comprise:
receiving a job submitted by a user;
determining a type of the job received;
initializing at least one of the secondary drivers or the secondary hardware components of the multi-function device based on the type of the job; and
deactivating the initialized at least one of the secondary drivers or the secondary hardware components of the multi-function device after completion of the received job.

18. The non-transitory computer readable medium as claimed in claim 15, wherein the initializing of the multi-function device, when the user selection is the light duty mode, further comprises:
initializing at least one of the secondary drivers or the secondary hardware components of the multi-function device based on a type of a job, when the job is detected in a memory of the multi-function device; and
deactivating the initialized at least one of secondary drivers or secondary hardware components of the multi-function device after completion of the job in the memory.

19. The non-transitory computer readable medium as claimed in claim 15, wherein the operations further comprise:
initializing the multi-function device with the primary drivers, the primary hardware components, the secondary drivers and the secondary hardware components that are required for complete functionality of the multi-function device, when the user selection is the heavy duty mode.

20. The non-transitory computer readable medium as claimed in claim 17, wherein the deactivating of the initialized at least one of secondary drivers or secondary hardware components is performed after the predetermined period of time after completion of the job.
